(19) United States
(12) Patent Application Publication
(10) Pub. No.: US 2025/0211690 A1
(43) Pub. Date: Jun. 26, 2025

(54) INFORMATION PROCESSING SYSTEM AND NON-TRANSITORY COMPUTER-READABLE RECORDING MEDIUM

(71) Applicant: FUJIFILM Business Innovation Corp., Tokyo (JP)

(72) Inventor: Jun NAGUMO, Kanagawa (JP)

(73) Assignee: FUJIFILM Business Innovation Corp., Tokyo (JP)

(21) Appl. No.: 18/653,359

(22) Filed: May 2, 2024

(30) Foreign Application Priority Data
Dec. 20, 2023 (JP) 2023-215056

(51) Int. Cl. H04N 1/00

(52) U.S. Cl. CPC H04N 1/00506; H04N 1/00427

(57) ABSTRACT

An information processing system includes a processor and a memory, wherein the processor generates setting information in which a setting value at a time of executing processing is stored for each of a plurality of function items and stores the setting information in the memory, and when reading and displaying the setting information stored in the memory, the processor arranges and displays the function item whose setting value is changed from an initial value to be higher in a display order than the function item whose setting value is not changed from the initial value.

### CROSS-REFERENCE TO RELATED APPLICATIONS

This application is based on and claims priority under 35 USC 119 from Japanese Patent Application No. 2023-215056 filed Dec. 20, 2023.

### BACKGROUND

### (i) Technical Field

The present disclosure relates to an information processing system and a non-transitory computer-readable recording medium.

### (ii) Related Art

JP7118686B discloses an information processing apparatus in which, when a setting history button is displayed on an operation screen, a setting value different from a default setting value among a plurality of setting values corresponding to the setting history button is preferentially displayed on the setting history button over the same setting value as the default setting value, so that a user can easily know the setting value corresponding to the setting history button.

JP2020-123235A discloses an image processing apparatus in which a difference between an initial value at a time of shipment from a factory and a setting value and a difference between an initial value set by a user as a default and a setting value are displayed on a setting history button, so that setting contents of the setting history button can be recognized.

### SUMMARY

Generally, in a case where certain processing is executed in an information processing apparatus, there are cases where setting values of a plurality of function items at a time of executing the processing are changed from initial values set in advance. However, since it is troublesome to change a setting value of a certain function item from the initial value every time certain processing is executed, a function of creating and registering new setting information whose setting value for each function item is changed from the initial value has been proposed. However, when newly created setting information is displayed, if the plurality of function items is always displayed in a display order set in advance, it will be difficult to distinguish between a function item whose setting value is changed from the initial value and a function item whose setting value is not changed from the initial value.

An object of the present invention is to provide an information processing system and a non-transitory computer-readable recording medium capable of making it easier to distinguish between a function item whose setting value is changed from an initial value and a function item whose setting value is not from an initial value than in a case where a plurality of function items is displayed in a display order set in advance, regardless of a state of the setting value.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor and a memory, wherein the processor generates setting information in which a setting value at a time of executing processing is stored for each of a plurality of function items and stores the setting information in the memory, and when reading and displaying the setting information stored in the memory, the processor arranges and displays the function item whose setting value is changed from an initial value to be higher in a display order than the function item whose setting value is not changed from the initial value.

### BRIEF DESCRIPTION OF THE DRAWINGS

Exemplary embodiments of the present invention will be described in detail based on the following figures, wherein:

FIG. 1 is a diagram illustrating a configuration of an image forming system according to an exemplary embodiment of the present disclosure;

FIG. 2 is a block diagram illustrating a hardware configuration of an image forming apparatus 10 according to an exemplary embodiment of the present disclosure;

FIG. 3 is a block diagram illustrating a functional configuration of the image forming apparatus 10 according to an exemplary embodiment of the present disclosure;

FIG. 4 is a diagram illustrating an example of a home screen in the image forming apparatus 10 according to an exemplary embodiment of the present disclosure;

FIG. 5 is a diagram illustrating an example of a copy application screen displayed when a user selects an icon 51 for a copy application;

FIG. 6 is a diagram illustrating an example of an initial value table in which a display order of function items and initial values of setting values for the respective function items are set;

FIG. 7 is a diagram illustrating a state in which the user changes setting contents of a copy application from the initial value and executes a copy job;

FIG. 8 is a diagram illustrating an example of job history information generated by executing a print job;

FIG. 9 is a diagram for describing a state in which the job history information is changed to setting information in a pinned state;

FIG. 10 is a diagram illustrating an example of a display screen when the user selects the setting information in the pinned state in the example of the display screen illustrated in FIG. 9;

FIG. 11 is a diagram illustrating an example of a table for storing the setting contents of the generated setting information in the pinned state when the setting information in the pinned state is generated;

FIG. 12 is a diagram for describing a flow of processing when a setting item whose setting value is changed from the initial value is disposed above the other setting items;

FIG. 13 is a diagram for describing a flow of processing when a setting item whose setting value is changed from the initial value is disposed above the other setting items;

FIG. 14 is a diagram for describing a flow of processing when a setting item whose setting value is changed from the initial value is disposed above the other setting items;

FIG. 15 is a diagram for describing a flow of processing when a setting item whose setting value is changed from the initial value is disposed above the other setting items; and

FIG. 16 is a diagram illustrating an example of a display screen when a function item whose setting value is changed from the initial value is disposed and displayed so as to be lower in a display order than a function item whose setting value is not changed from the initial value.

### DETAILED DESCRIPTION

Next, exemplary embodiments of the present disclosure will be described in detail with reference to the drawings.

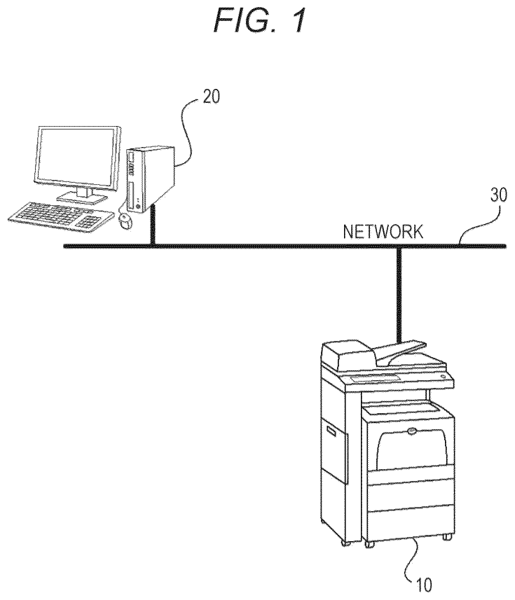

FIG. 1 is a diagram illustrating a configuration of an image forming system according to an exemplary embodiment of the present disclosure.

As illustrated in FIG. 1, the image forming system according to an exemplary embodiment of the present disclosure includes an image forming apparatus 10 and a terminal device 20 that are connected to each other via a network 30. The terminal device 20 generates print data and transmits the generated print data to the image forming apparatus 10 via the network 30. The image forming apparatus 10 receives the print data transmitted from the terminal device 20 and outputs an image corresponding to the print data onto paper. The image forming apparatus 10 is a so-called multifunction peripheral having a plurality of functions such as a print function, a scan function, a copy function, and a facsimile function.

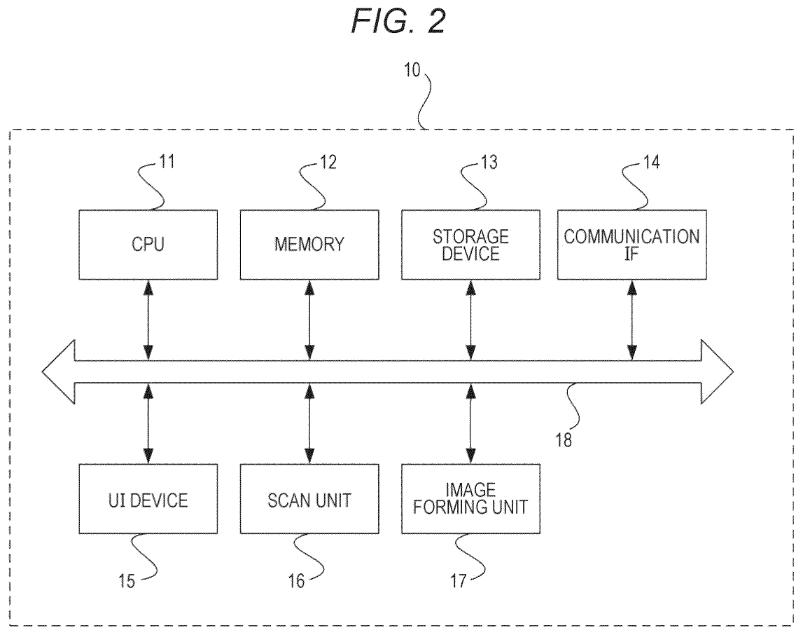

Next, FIG. 2 illustrates a hardware configuration of the image forming apparatus 10 in the image forming system according to the present exemplary embodiment.

As illustrated in FIG. 2, the image forming apparatus 10 includes a CPU 11, a memory 12, a storage device 13 such as a hard disk drive, and a communication interface (abbreviated as IF) 14 that performs data transmission and reception with an external device or the like via the network 30, a user interface (abbreviated as UI) including a touch panel or a liquid crystal display and a keyboard, a device 15, a scan unit 16, and an image forming unit 17. These components are connected to each other via a control bus 18.

The image forming units 17 print an image on a recording medium, such as a printing sheet, through steps such as charging, exposure, development, transfer, and fixing.

The CPU 11 is a processor that executes predetermined processing on the basis of a control program stored in the memory 12 or the storage device 13 to control the operation of the image forming apparatus 10. In the present exemplary embodiment, the CPU 11 reads and executes the control program stored in the memory 12 or the storage device 13, but the present invention is not limited to this configuration. The control program may be provided in a form of being recorded in a computer-readable recording medium. For example, the program may be provided in a form recorded in an optical disc such as a compact disc (CD)-ROM or a digital versatile disc (DVD)-ROM, or in a form recorded in a semiconductor memory such as a universal serial bus (USB) memory or a memory card. The control program may be acquired from an external device via a communication line connected to the communication interface 14. This control program may be provided, for example, as independent application software, or may be incorporated into software of each device as one function of the image forming apparatus 10.

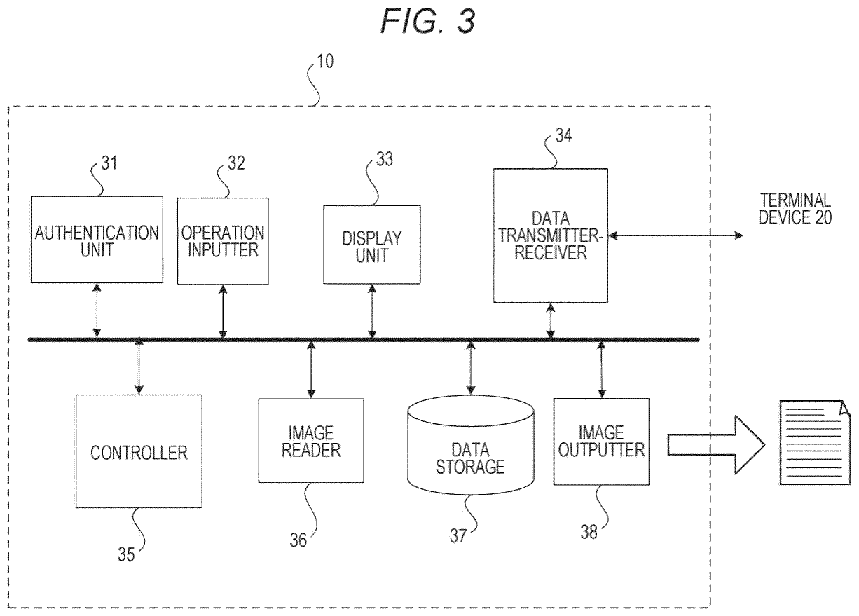

FIG. 3 is a block diagram illustrating a functional configuration of the image forming apparatus 10 implemented by execution of the control program described above.

As illustrated in FIG. 3, the image forming apparatus 10 according to the present exemplary embodiment includes an authentication unit 31, an operation inputter 32, a display unit 33, a data transmitter-receiver 34, a controller 35, an image reader 36, a data storage 37, and an image outputter 38.

The authentication unit 31 executes authentication processing for a user who attempts to use the image forming apparatus 10. The display unit 33 is controlled by the controller 35 and displays various information to the user. The operation inputter 32 inputs information of various operations performed by the user. The data transmitter-receiver 34 transmits and receives data to and from an external device such as the terminal device 20.

The image outputter 38 outputs an image onto a recording medium such as a printing sheet on the basis of the control by the controller 35. The image reader 36 reads a document image from a set document on the basis of the control by the controller 35.

The controller 35 controls the overall operation of the image forming apparatus 10, and performs control of generating print data on the basis of a print job received from the terminal device 20 via the data transmitter-receiver 34 and outputting the generated print data from the image outputter 38, control of reading a document image by the image reader 36, and the like. The data storage 37 stores job history information indicating an execution history of various jobs such as a print job, a scan job, a copy job, and a facsimile transmission job executed by the controller 35, and setting information in which a setting value at a time of executing processing is stored for each setting item. Here, the job history information is history information of processing content of jobs executed in the past.

By selecting and executing this job history information in the image forming apparatus 10 according to the present exemplary embodiment, it is possible to re-execute a job having the same setting content as a job executed in the past.

Next, when a job is executed by a user using the image forming apparatus 10, new job history information is generated every time the job is executed. However, a data storage area is limited, and if all the pieces of job history information are stored, there is a possibility that the data storage area is insufficient. Therefore, an upper limit is set such that, for example, only the latest 200 jobs are allowed to remain as job history information, and job history information whose execution date and time exceed the upper limit is deleted in ascending order of date and time of execution.

Therefore, in the image forming apparatus 10 according to the present exemplary embodiment, it is possible to perform pinning setting so that a job history that is not desired to be deleted is not a deletion target. A pinned job history is not deleted and is left even if the number of subsequently executed jobs exceeds the upper limit.

Furthermore, not only in a case where a job is actually executed, but also in a case where setting information in which a setting value at the time of executing processing of a job or the like is set for each parameter which is a plurality of function items is created and stored, and the stored setting information is selected, it is possible to execute a job with setting contents set in the setting information.

The setting information created in this way is not deleted by the job history and is continuously saved as the setting information in the pinned state. In the following description, both pinned job history information and setting information set on the basis of certain setting contents will be described as setting information in the pinned state or pinned setting information.

In such setting information in the pinned state, the setting values of the plurality of function items are changed from initial values set in advance. However, when a new job is to be executed by using the setting information in the pinned state generated in advance, if the plurality of function items is always displayed in a display order set in advance, it will be difficult to distinguish between a function item whose setting value is changed from the initial value and a function item whose setting value is not changed from the initial value. As a result, the user cannot know what the setting contents of the job to be executed from now are like.

Therefore, in the image forming apparatus 10 according to the present exemplary embodiment, by performing processing as described below, it is made easier to distinguish between a function item whose setting value is changed from the initial value and a function item whose setting value is not changed from the initial value than in a case where the plurality of function items is displayed in a display order set in advance, regardless of a state of the setting value.

First, an operation method when the setting information in the pinned state is created and stored in the image forming apparatus 10 according to the present exemplary embodiment will be described with reference to the drawings.

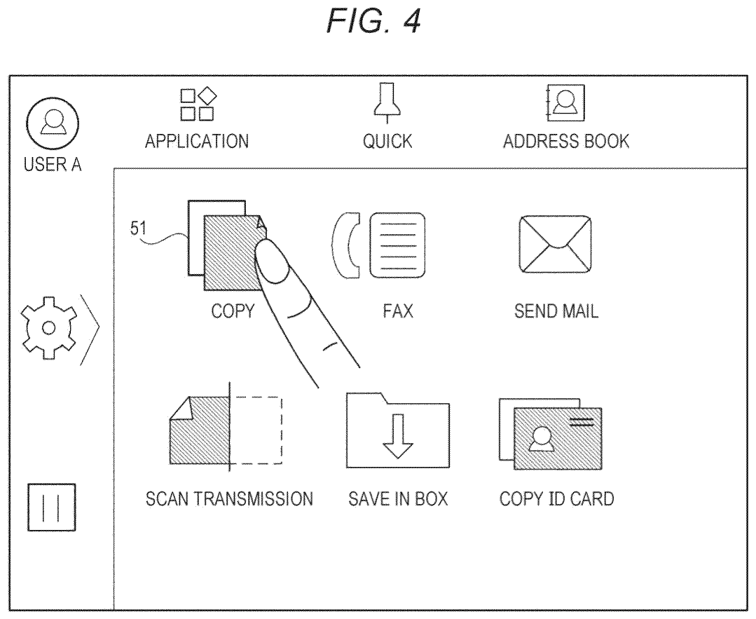

FIG. 4 illustrates an example of a home screen in the image forming apparatus 10 according to the present exemplary embodiment of the present disclosure.

In the example of the home screen illustrated in FIG. 4, applications for executing various functions such as copying, faxing, and scanning are displayed on a touch panel. FIG. 4 illustrates a state in which the user selects an icon 51 for a copy application to use the copy function.

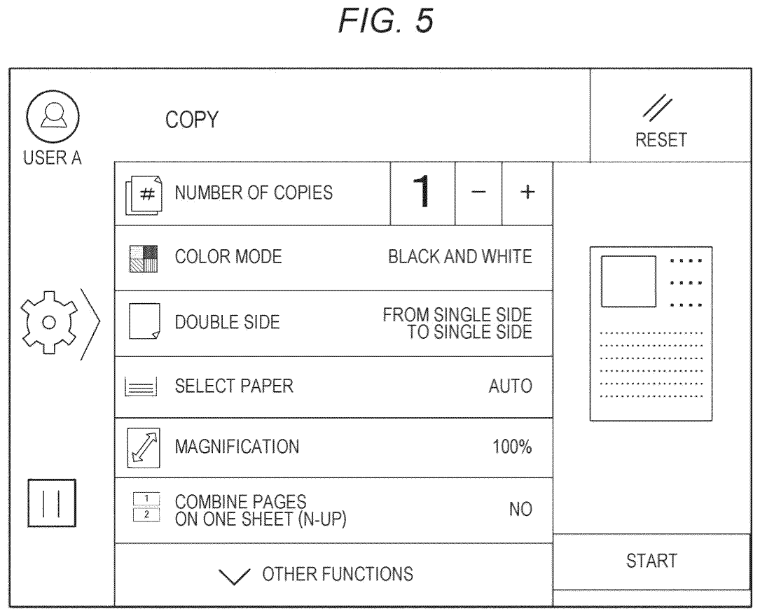

FIG. 5 illustrates an example of a copy application screen that is displayed when the user selects the icon 51 for the copy application. On the copy application screen illustrated in FIG. 5, function items (parameters) of the number of copies, color mode, double side, paper selection, magnification, and combining pages on one sheet (N-up) are displayed in a certain display order. Then, to change a setting value of a function item other than the currently displayed function item, the user needs to operate an operation button called “other functions” to display the function item other than the currently displayed function item. To change the setting value of the function item that is still not displayed, the user needs to scroll a list of the plurality of function items to display a function item whose setting value is to be changed.

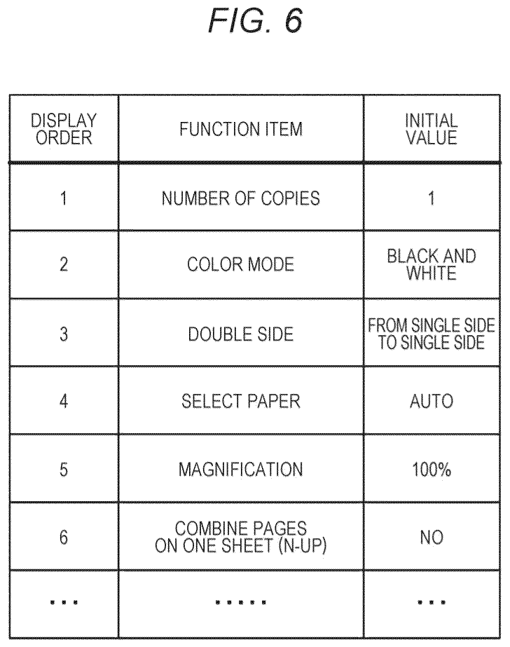

In this way, on the copy application screen displayed by the user selecting the icon 51 for the copy application, the display order of function items and the initial values of the setting values for the respective function items are determined by an initial value table. An example of such an initial value table is illustrated in FIG. 6.

The initial value table illustrated in FIG. 6 shows that initial values are set for the respective function items of the number of copies, color mode, double side, paper selection, magnification, and combining pages on one sheet (N-up). The copy application screen illustrated in FIG. 5 is generated by configuring the display order and the setting values on the basis of the initial value table illustrated in FIG. 6.

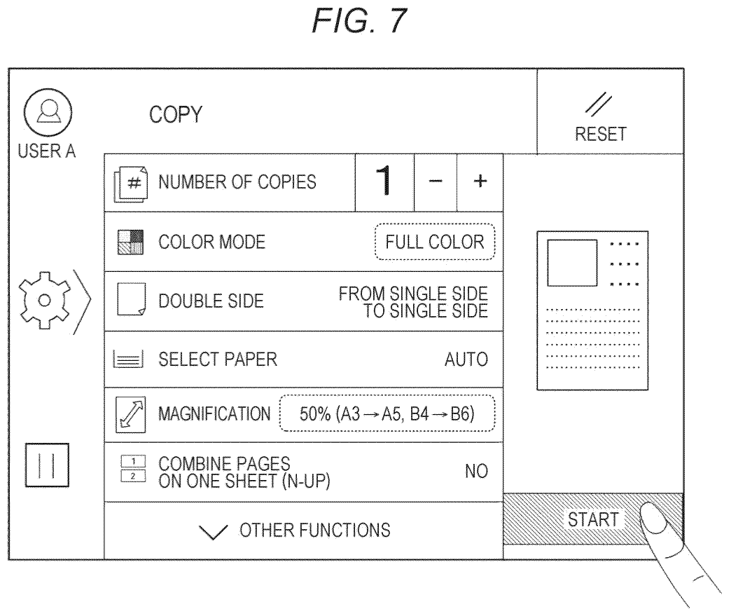

Then, FIG. 7 illustrates a state in which the user changes the setting contents of the copy application from the initial value and executes a copy job. An example of the display screen illustrated in FIG. 7 illustrates a state in which the setting value of the setting item of color mode is changed from black and white to full color, the setting value of the setting item called magnification is changed from 100% to 50%, and a start button is operated.

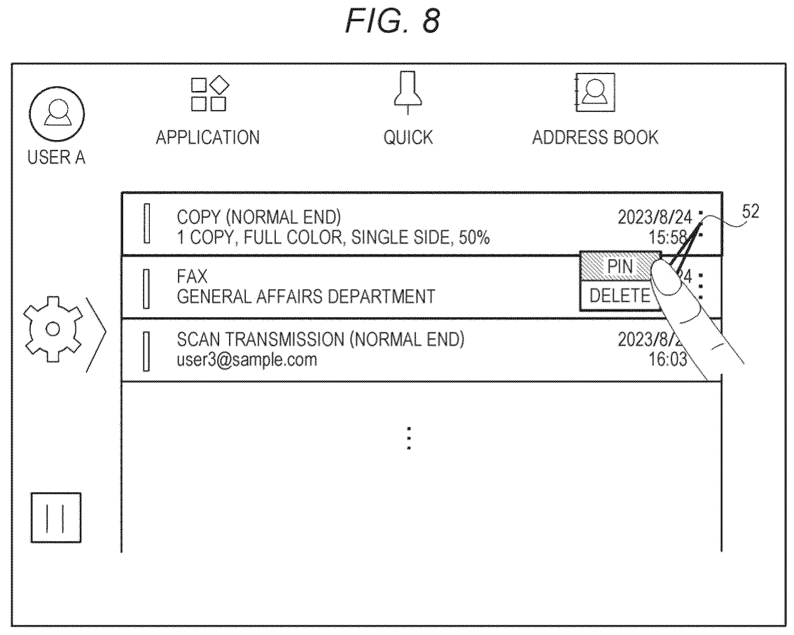

Then, FIG. 8 illustrates an example of the job history information generated by executing the print job in this way. The example of the display screen in FIG. 8 shows a state in which a job history information displayed as “copy (normal end), one copy, full-color, single side, 50%” is generated by executing a certain print job.

Here, when the job history information is set as the setting information in the pinned state in order to leave the setting contents of the print job executed by the user, an operation menu icon 52 of the job history information is operated. Then, various operation menus for the job history information are displayed. Here, the user selects an operation menu “pinning” from among the plurality of displayed operation menus.

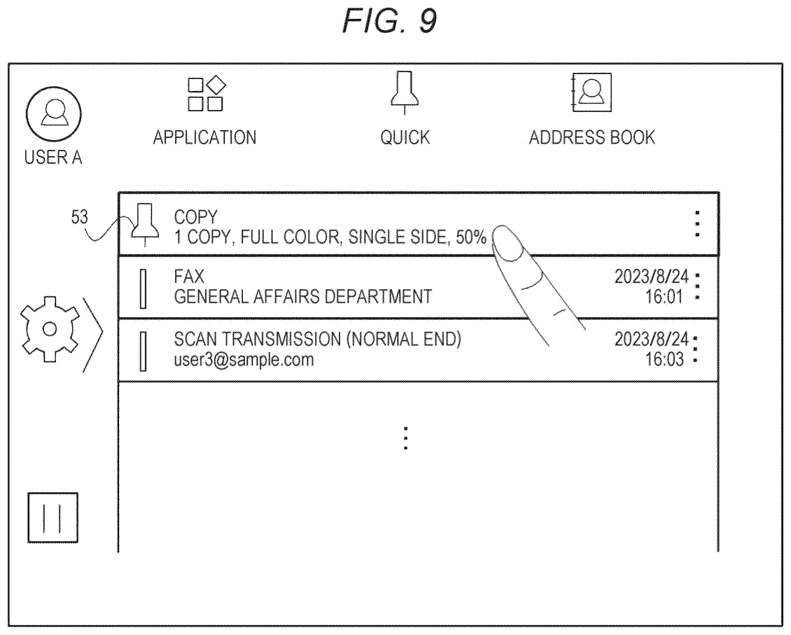

Then, as illustrated in FIG. 9, the job history information is changed to the setting information in the pinned state. A pinning mark 53 indicating the pinned state is indicated in the setting information in the pinned state.

Upon reception of an instruction to generate the setting information in the pinned state, the controller 35 generates the setting information in the pinned state in which the setting value at the time of executing processing is stored for each of the plurality of function items, and stores the setting information in the data storage 37. Next, when reading and displaying the setting information in the pinned state stored in the data storage 37, the controller 35 arranges and displays the function item whose setting value is changed from the initial value to be higher in the display order than the function item whose setting value is not changed from the initial value.

Specifically, the controller 35 refers to the initial value table in which the initial value is stored for each of the plurality of function items, and compares the setting value set for each function item of the setting information in the pinned state to be displayed with the initial value stored in the initial value table. Then, the controller 35 determines the display order of the plurality of function items by setting the function item whose setting value is not changed from the initial value to be in the display order according to an order of the initial value table and setting the function item whose setting value is changed from the initial value to be higher in the display order regardless of the order of the initial value table.

Furthermore, the controller 35 may display a function item whose setting value is changed from the initial value in a display method that shows that the setting value is changed from the initial value. For example, the controller 35 displays the function item whose setting value is changed from the initial value in a display color different from a display color of the function item whose setting value is not changed from the initial value. The controller 35 may add a mark, a symbol, a character, or the like indicating that the setting value is changed from the initial value to the function item whose setting value is changed from the initial value and display the function item.

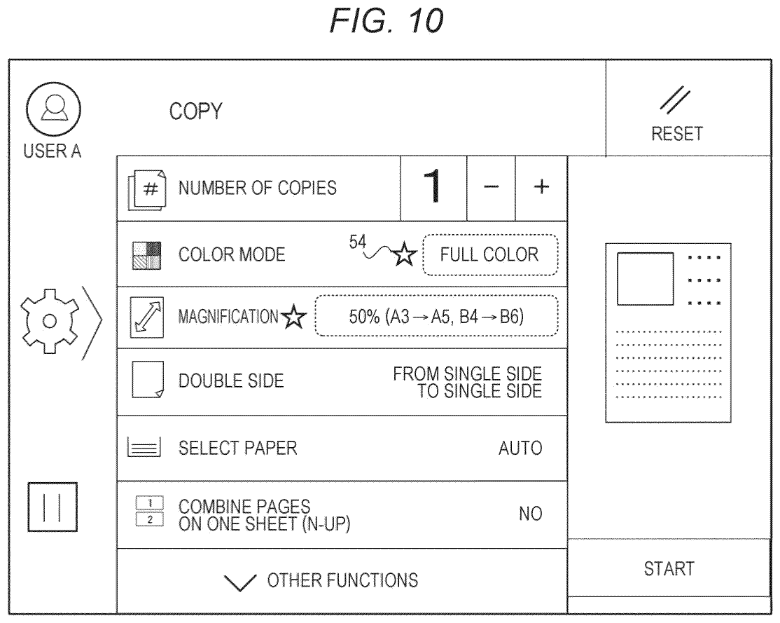

Next, FIG. 10 illustrates an example of the display screen when the user selects the setting information in the pinned state in the example of the display screen illustrated in FIG. 9.

The example of the display screen illustrated in FIG. 10 shows that the setting items of color mode and magnification whose setting values is changed from the initial values are disposed to be higher in the display order than the setting items of double side, paper selection, and combining pages on one sheet (N-up) whose setting values is not changed from the initial values.

In FIG. 10, a star icon 54 indicating that the setting value is changed from the initial value is added for display to the setting items of color mode and magnification whose setting values are changed from the initial values.

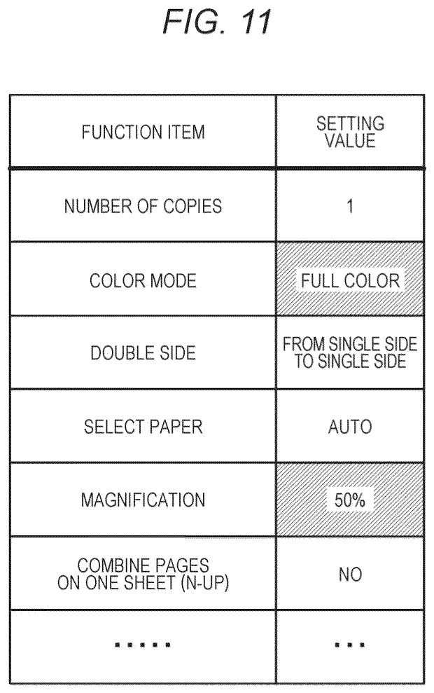

Next, a method for enabling the controller 35 to arrange the setting item whose setting value is changed from the initial value to be higher than the other setting items will be described with reference to FIGS. 11 to 15.

When the setting information in the pinned state is generated, the controller 35 stores the setting contents of the generated setting information in the pinned state in the data storage 37 by using a table as illustrated in FIG. 11. In FIG. 11, description will be made assuming that the setting values of the setting items of color mode and magnification are changed from the initial values.

When the setting information in the pinned state is selected and the setting contents are displayed on the display screen, the controller 35 compares the setting contents of the setting information in the pinned state with the setting content of each function item in the initial value table illustrated in FIG. 6. Specifically, the controller 35 sequentially compares the initial value of each function item in the initial value table with the setting value of each function item of the setting information in the pinned state to be displayed, and determines whether the setting value of each function item of the setting information in the pinned state to be displayed is changed from the initial value.

Then, the controller 35 determine the display order of the function item whose setting value is not changed from the initial value on the basis of the display order in the initial value table. Then, the controller 35 determines the display order such that the function item whose setting value is changed from the initial value is higher than the function item whose setting value is not changed from the initial value regardless of the display order in the initial value table.

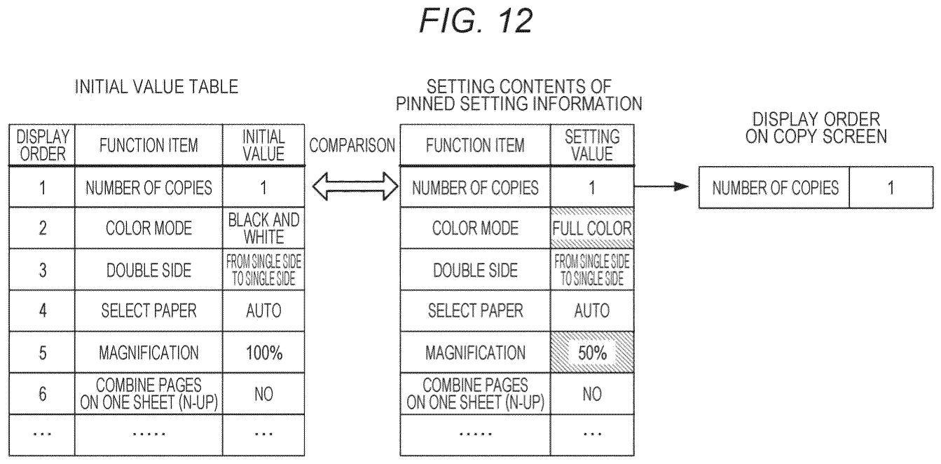

For example, as illustrated in FIG. 12, the controller 35 determines whether the initial value of the function item of the number of copies in the initial value table coincides with the setting value of the function item of the number of copies of the setting information in the pinned state to be displayed. In this case, the initial value and the setting value are both 1 and coincide with each other, and thus the controller 35 maintains the display order of the function item of the number of copies in the initial value table.

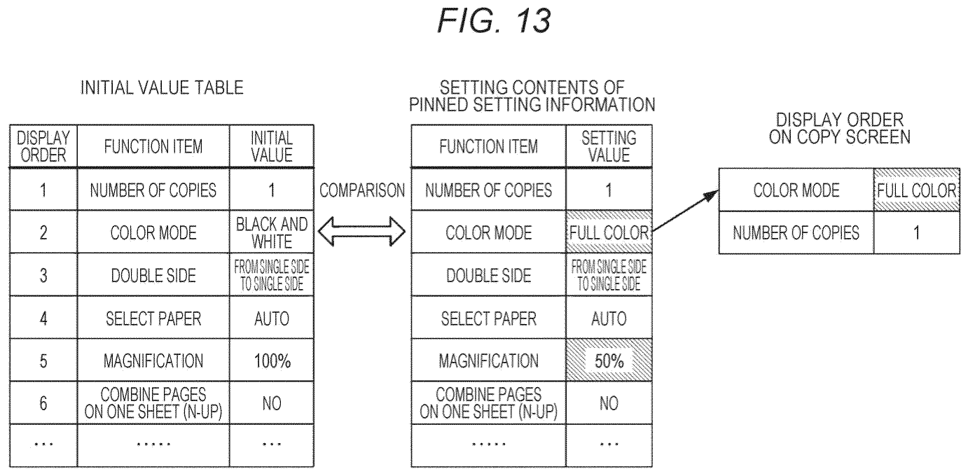

Next, as illustrated in FIG. 13, the controller 35 determines whether setting value of the setting information in the pinned state is changed from the initial value in the function item of color mode. Here, although the initial value of the function item of color mode is black and white, the setting value of the setting information in the pinned state is full color, which is changed from the initial value. Therefore, the controller 35 sets the display order of the function item of color mode to be higher than the display order of the function item of the number of copies regardless of the display order in the initial value table.

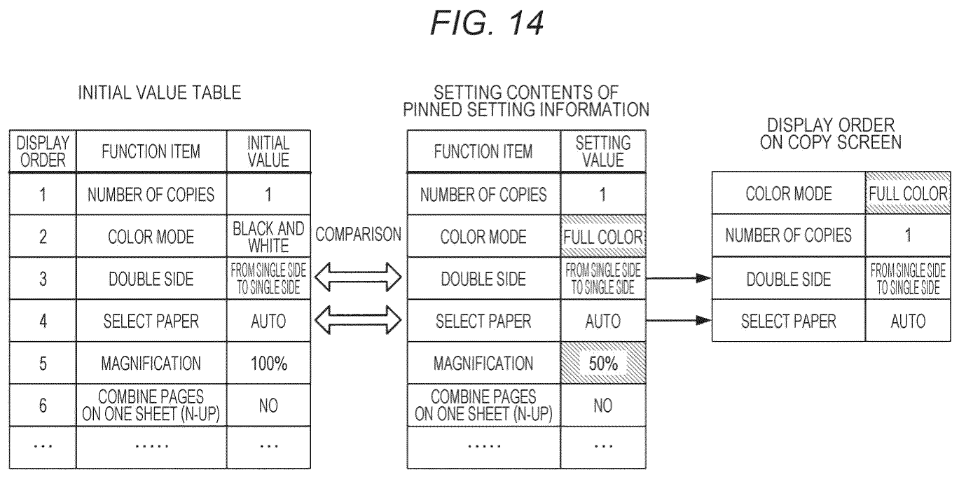

Next, as illustrated in FIG. 14, the controller 35 determines whether setting value of the setting information in the pinned state is changed from the initial value in each of the function items of double side and paper selection. Here, since all the function items maintain the initial values, the controller 35 maintains the display order of the function items of double side and paper selection as the display order in the initial value table.

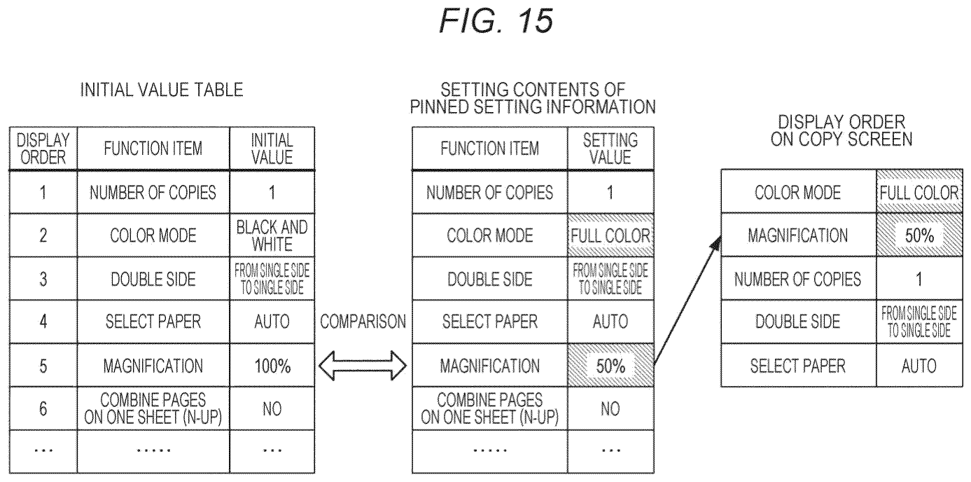

Furthermore, as illustrated in FIG. 15, the controller 35 determines whether the setting value of the setting information in the pinned state is changed from the initial value in the function item of magnification. Here, although the initial value of the function item of magnification is 100%, the setting value of the setting information in the pinned state is 50%, which is changed from the initial value. Therefore, the controller 35 sets the display order of the function item of magnification to be higher than the display order of the function items of the number of copies, double side, and paper selection regardless of the display order in the initial value table.

In this way, the controller 35 sequentially compares the setting value of each function item of the setting information in the pinned state with the initial value in the initial value table to sequentially determine the display order of each function item when displaying the setting contents of the setting information in the pinned state.

[When Function Item Whose Setting Value is Changed from Initial Value is Displayed Lower]

In the exemplary embodiment described above, the function item (parameter) whose setting value is changed from the initial value is displayed higher than the function item whose setting value is not changed from the initial value. However, the function item whose setting value has been changed from the initial value when the setting information in the pinned state is generated is a function item whose setting value has been set on the basis of the user's intention. Therefore, when a job is executed by using the setting information in the pinned state, a possibility that the setting value will be changed again is considered to be lower in the function item whose setting value is changed from the initial value than in the function item whose setting value is not changed from the initial value.

Therefore, if only the function item whose setting value is changed from the initial value is displayed higher, when the user attempts to change the setting value of the function item whose setting value is not changed from the initial value, there is a possibility that the user needs to scroll the list of the function items to search for the function item whose setting value is to be changed.

Therefore, when reading and displaying the setting information in the pinned state stored in the data storage 37, the controller 35 may arrange and display the function item whose setting value is changed from the initial value to be lower in the display order than the function item whose setting value is not changed from the initial value.

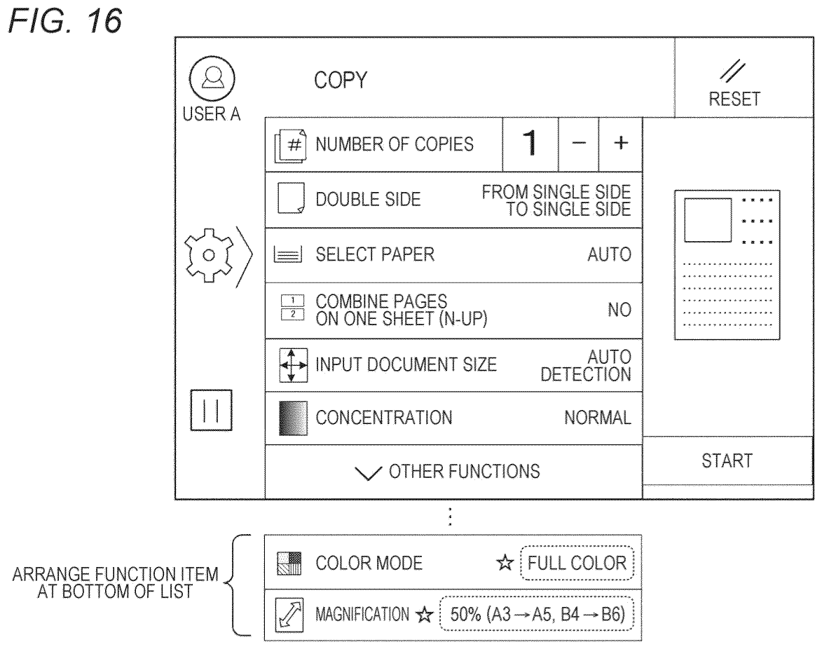

FIG. 16 illustrates an example of a display screen when a function item whose setting value is changed from the initial value is disposed and displayed so as to be lower in the display order than the function item whose setting value is not changed from the initial value as described above.

With reference to FIG. 16, it is found that the function items of color mode and magnification whose setting values are changed from the initial values are disposed lower than the other function items whose setting values are not changed from the initial values. Specifically, on the display screen illustrated in FIG. 16, only the setting items higher in the display order are displayed, and the setting items lower in the display order are to be displayed by scrolling with operation of the operation button of the other functions.

Whether it is more convenient for the user to arrange and display the function item whose setting value is changed from the initial value to be higher in the display order than the function item whose setting value is not changed from the initial value or to arrange and display the function item whose setting value is changed from the initial value to be lower in the display order than the function item whose setting value is not changed from the initial value depends on how the user use setting information in the pinned state. Therefore, the controller 35 may receive, from the user, a selection as to whether the function item whose setting value is changed from the initial value is to be displayed higher or lower than the function item whose setting value is not changed from the initial value.

Next, when reading and displaying the setting information in the pinned state stored in the data storage 37, if the controller 35 receives a selection to display the function item whose setting value is changed from the initial value to be higher, the controller 35 arranges and displays the function item whose setting value is changed from the initial value to be higher in the display order than the function item whose setting value is not changed from the initial value. When reading and displaying the setting information in the pinned state stored in the data storage 37, if the controller 35 receives a selection to display the function item whose setting value is changed from the initial value to be lower, the controller 35 arranges and displays the function item whose setting value is changed from the initial value to be lower in the display order than the function item whose setting value is not changed from the initial value.

In each of the exemplary embodiments, the processor refers to a processor in a broad sense, and includes general-purpose processors (for example, a central processing unit (CPU) and the like) and dedicated processors (for example, a graphics processing unit (GPU), an application specific integrated circuit (ASIC), a field programmable gate array (FPGA), a programmable logic device, and the like).

The operation of the processor in each of the exemplary embodiments may be performed not only by one processor but also by a plurality of processors existing at physically separated positions in cooperation with each other. In addition, the order of the operations of the processor is not limited to only the order described in the exemplary embodiments but may be appropriately changed.

A “system” in the present exemplary embodiment includes both a system configured by a plurality of devices and a system configured by a single device.

### [Modification]

The exemplary embodiments have been described by using a case where the present disclosure is applied to the image forming apparatus 10, but the present disclosure is not limited to this case. The present disclosure can be similarly applied to an information processing apparatus and an information processing system capable of storing setting information in which a setting value at the time of executing processing is set for each of a plurality of function items and executing a process on the basis of the stored setting information.

### [Supplementary Notes]

Hereinafter, supplementary notes on preferred embodiments of the present disclosure will be provided.

(((1)))

An information processing system comprising a processor and a memory, wherein the processor generates setting information in which a setting value at a time of executing processing is stored for each of a plurality of function items and stores the setting information in the memory, and when reading and displaying the setting information stored in the memory, the processor arranges and displays the function item whose setting value is changed from an initial value to be higher in a display order than the function item whose setting value is not changed from the initial value.

(((2)))

The information processing system according to (((1))), wherein the processor refers to an initial value table in which the initial value is stored for each of the plurality of function items, compares the setting value set for each of the function items of the setting information to be displayed with the initial value stored in the initial value table, and determines the display order of the plurality of function items by setting the function item whose setting value is not changed from the initial value to be in the display order according to an order of the initial value table and setting the function item whose setting value is changed from the initial value to be higher in the display order regardless of the order of the initial value table.

(((3)))

An information processing system comprising a processor and a memory, wherein the processor generates setting information in which a setting value at a time of executing processing is stored for each of a plurality of function items and stores the setting information in the memory, and when reading and displaying the setting information stored in the memory, the processor arranges and displays the function item whose setting value is changed from an initial value to be lower in a display order than the function item whose setting value is not changed from the initial value.

(((4)))

The information processing system according to any one of (((1)) to (((3))), wherein the processor displays the function item whose setting value is changed from the initial value in a display method that shows that the setting value is changed from the initial value.

(((5)))

The information processing system according to (((4))), wherein the processor displays the function item whose setting value is changed from the initial value in a display color different from a display color of the function item whose setting value is not changed from the initial value.

(((6)))

An information processing system comprising a processor and a memory, wherein the processor generates setting information in which a setting value at a time of executing processing is stored for each of a plurality of function items and stores the setting information in the memory, receives, from a user, a selection as to whether the function item whose setting value is changed from an initial value is to be displayed higher or lower than the function item whose setting value is not changed from the initial value, and when reading and displaying the setting information stored in the memory, upon reception of the selection to display higher, the processor arranges and displays the function item whose setting value is changed from the initial value to be higher in a display order than the function item whose setting value is not changed from the initial value, and upon reception of the selection to display lower, the processor arranges and displays the function item whose setting value is changed from the initial value to be lower in the display order than the function item whose setting value is not changed from the initial value.

(((7)))

A non-transitory computer-readable recording medium that stores a program that causes a computer to generate setting information in which a setting value at a time of executing processing is stored for each of a plurality of function items and store the setting information, and when reading and displaying the setting information having been stored, arrange and display the function item whose setting value is changed from an initial value to be higher in a display order than the function item whose setting value is not changed from the initial value.

(((8)))

A non-transitory computer-readable recording medium that stores a program that causes a computer to generate setting information in which a setting value at a time of executing processing is stored for each of a plurality of function items and store the setting information, and when reading and displaying the setting information having been stored, arrange and display the function item whose setting value is changed from an initial value to be lower in a display order than the function item whose setting value is not changed from the initial value.

(((9)))

A non-transitory computer-readable recording medium that stores a program that causes a computer to generate setting information in which a setting value at a time of executing processing is stored for each of a plurality of function items and store the setting information, receive, from a user, a selection as to whether the function item whose setting value is changed from an initial value is to be displayed higher or lower than the function item whose setting value is not changed from the initial value, and when reading and displaying the setting information having been stored, upon reception of the selection to display higher, arrange and display the function item whose setting value is changed from the initial value to be higher in a display order than the function item whose setting value is not changed from the initial value, and upon reception of the selection to display lower, arrange and display the function item whose setting value is changed from the initial value to be lower in the display order than the function item whose setting value is not changed from the initial value.

What is claimed is:

1. An information processing system comprising:
a processor; and
a memory,
wherein the processor generates setting information in which a setting value at a time of executing processing is stored for each of a plurality of function items and stores the setting information in the memory, and
when reading and displaying the setting information stored in the memory, the processor arranges and displays the function item whose setting value is changed from an initial value to be higher in a display order than the function item whose setting value is not changed from the initial value.

2. The information processing system according to claim 1, wherein
the processor refers to an initial value table in which the initial value is stored for each of the plurality of function items, compares the setting value set for each of the function items of the setting information to be displayed with the initial value stored in the initial value table, and determines the display order of the plurality of function items by setting the function item whose setting value is not changed from the initial value to be in the display order according to an order of the initial value table and setting the function item whose setting value is changed from the initial value to be higher in the display order regardless of the order of the initial value table.

3. An information processing system comprising:
a processor; and
a memory,
wherein the processor generates setting information in which a setting value at a time of executing processing is stored for each of a plurality of function items and stores the setting information in the memory, and when reading and displaying the setting information stored in the memory, the processor arranges and displays the function item whose setting value is changed from an initial value to be lower in a display order than the function item whose setting value is not changed from the initial value.

4. The information processing system according to claim 1, wherein the processor displays the function item whose setting value is changed from the initial value in a display method that shows that the setting value is changed from the initial value.

5. The information processing system according to claim 2, wherein the processor displays the function item whose setting value is changed from the initial value in a display method that shows that the setting value is changed from the initial value.

6. The information processing system according to claim 3, wherein the processor displays the function item whose setting value is changed from the initial value in a display method that shows that the setting value is changed from the initial value.

7. The information processing system according to claim 4, wherein the processor displays the function item whose setting value is changed from the initial value in a display color different from a display color of the function item whose setting value is not changed from the initial value.

8. A non-transitory computer-readable recording medium that stores a program that causes a computer to generate setting information in which a setting value at a time of executing processing is stored for each of a plurality of function items and store the setting information, and when reading and displaying the setting information having been stored, arrange and display the function item whose setting value is changed from an initial value to be higher in a display order than the function item whose setting value is not changed from the initial value.
